(19) United States
(12) Patent Application Publication
(10) Pub. No.: US 2002/0103921 A1
(43) Pub. Date: Aug. 1, 2002

(54) Method and system for routing broadband internet traffic

(76) Inventors: Shekar Nair, San Jose, CA (US); David Wilkins, San Jose, CA (US); Frank Lawrence, Morgan Hill, CA (US); Fred Dominikus, San Jose, CA (US); Matthew Glenn, San Jose, CA (US); Nathaniel Ingersoll, Nevada City, CA (US); Paranjeet Singh, San Jose, CA (US); Troy Dixler, Deerfield, IL (US)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 09/774,016

(22) Filed: Jan. 31, 2001

(51) Int. Cl. G06F 15/173; G06F 15/16

(52) U.S. Cl. 709/232; 709/238

(57) ABSTRACT

A method and system for providing broadband Internet access, possibly on a wholesale basis. High-bandwidth Internet traffic over an Internet backbone is channelized onto input/output ports of a routing device. The routing device contains multiple, individual, full-function routers, each capable of routing at least some portion of the high-bandwidth Internet traffic. The channels and/or ports are grouped to define a network interface, and traffic over the network interface is assigned to one of the individual routers for processing. Routing and forwarding information is stored on a plurality of line cards, which forward the Internet traffic at line speed once routing instantiations are performed by the routers. A network interface and router(s) can be assigned to a customer, either for the customer to use or to provide to a secondary user. Customer access can be altered as needed, simply by reassigning, adding or removing the router(s) and/or line card(s). Each of the routers are logically and physically independent of one another, to provide reliability and flexibility in routing the Internet traffic. In one embodiment, all of the routers and associated ports and line cards are contained within a single chassis.

### BACKGROUND OF THE INVENTION

1. Field of the Invention

The present invention relates to the routing of broadband service to users in a flexible, reliable and scaleable manner. More particularly, the present invention relates to an arrangement of routing that is capable of providing broadband services on a port-by-port basis.

2. Discussion of the Related Art

As the Internet has grown in size, scope and content, various methods of providing access to the Internet have also developed. For example, some Internet Service Providers typically provide a bank of modems to users for dial-up access. Similarly, service providers may provide broadband access; i.e., extremely high-capacity, high-speed access such as DSL that is “always on.”

Dial-up users (service provider customers) must vie for access to a limited number of the service provider's modems, which can result in missed or dropped connections. Also, such service providers conventionally provide local dial-up access to their particular customer base, so that the customers may avoid long-distance dialing charges. As a service provider expands its presence and increases its number of customers, it must also expand its number of dial-up modems. This often entails building and providing additional, local points-of-presence (POPs) for new groups of customers. However, such infrastructure is often difficult and expensive for the service providers to maintain.

Additionally, even if service providers could effectively and conveniently administer dial-up access, such access would not be capable of meeting the connection speed and capacity requirements of many end users. Therefore, the need for broadband access has increased dramatically.

Broadband service is typically provided by service providers using routers to direct customer data over the network, where these routers perform their function over a finite number of input/output ports on each router (discussed in more detail below). However, as with dial-up access, it is extremely difficult for service providers to establish and maintain the infrastructure necessary to provide broadband access, especially as the provider's presence and number of customers increase over time.

For example, as the provider's presence and customer base increase, the provider may be required to establish new physical POPs, perhaps in separate cities. Establishing new POPs requires a substantial outlay of money; providers must identify and lease/purchase appropriate real estate, purchase additional equipment, hire new staff, etc. Appreciable time is necessary for a service provider to recoup these costs.

Another problem faced by broadband providers is the need for a physical network capable of providing broadband access (e.g., laying and maintaining fiber-optic cable). In this regard, very large carriers (such as AT&T and MCI) have developed large-scale, high-speed, high-bandwidth networks known as Internet backbones. Although these carriers are technically capable of supplying (broadband or dial-up) Internet access to consumers and businesses, the cost of building and maintaining their networks together with labor-intensive customer service reduces profit margins for these carriers incrementally as their customer base increases.

In short, providing either dial-up or broadband Internet access in a scaleable, efficient, cost-effective manner is very difficult for a given service provider, especially as the provider's presence and customer base increase. Dial-up access providers have recently dealt with this problem by working in concert with larger carriers; that is, the carriers maintain a large bank of modems, where each modem is assigned to a particular service provider. The service providers lease the modems from the carrier on an as-needed basis, and end users (i.e., customers of the service providers) may dial directly to the carrier-maintained modems for Internet access. The service providers pay a leasing fee to the carrier and charge an additional fee to the end user, where the additional fee includes customer service and other value-added features. Thus, the carrier and provider may focus on their respective areas of expertise.

It would be convenient if this wholesale model of providing Internet access could be extended to the provisioning of broadband access. In other words, it would be advantageous if service providers could lease router access from carriers. However, with conventional routers, all ports on the router would have to be assigned to a single service; e.g., the service provider that is operating that router. This is because a single processor (the main route switch processor) performs all of the routing functionality for a single customer (service provider), and all ports are associated with that processor.

As a result, the service providers would have to co-locate their own physical routers within the POPs of the carrier. This would consume valuable rack space of the carrier, and limit the revenue obtained by the carrier to the physical rack space that is utilized. Moreover, since the ports cannot be individually configured and managed, the service provider would still have to purchase a router that may be too large or, ultimately, too small for its customer base.

Thus, conventional routers are not very flexible or efficient when it comes to matching up with the changing needs of service providers in providing broadband access.

### SUMMARY OF THE INVENTION

The present invention relates to a method and system for routing broadband Internet access on a port-by-port basis, through the use of a plurality of full-function routers within a single chassis. The present invention can thus be used to provide broadband Internet access to multiple service providers in a manner that is flexible, reliable, scaleable and cost-effective.

The present invention makes use of a Distributed Service Router (DSR), which is a full-function router contained within a CPU card herein referred to as the DSR Card. All route processing is physically distributed on these cards, so that a port, portions of a port, or multiple ports may be assigned to a particular service provider, in accordance with that provider's needs. This functionality allows carriers to reserve and assign broadband services on a port-by-port basis, and these services can then be associated with or coupled to one or more Distributed Service Routers (DSRs) within the system. This may mean multiple ports assigned to a DSR, a single port assigned to a DSR, or only a subset of channels on a single port assigned to a DSR. Additionally, if necessary, more than one DSR may be assigned to a set of channels and/or ports. This flexible configuration environment can provide provisioning that allows carriers to create multiple complete router instantiations and offer services on demand, while maintaining isolation between customers.

A given DSR Card may contain one or more DSRs, depending on the routing requirements imposed upon each DSR. All DSRs can be contained within a single chassis and completely isolated from one another, both physically and logically. In this way, reliability is increased and there are no security issues or performance constraints between multiple service providers using the ports within the same chassis.

With the present invention, service providers need not purchase any more or less broadband Internet access than they currently need for their business. Carriers can experience gains over physical router co-location through co-locating within a single chassis, thereby preserving rack space and increasing revenue on a per-port basis.

Other features and advantages of the invention will become apparent from the following drawings and description.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIGS. 1A and 1B are rear and front views, respectively, of a chassis in accordance with one embodiment of the invention.

FIG. 2 demonstrates a hardware overview of a system implementing one embodiment of the present invention.

FIG. 3 demonstrates a typical packet flow according to one embodiment of the invention.

FIG. 4 demonstrates a software system implementing one embodiment of the present invention.

FIG. 5 demonstrates an example of hot-standby DSRs according to one embodiment of the invention

### DETAILED DESCRIPTION

While the present invention is described below with respect to various explanatory embodiments, various features of the present invention may be extended to other applications as would be apparent.

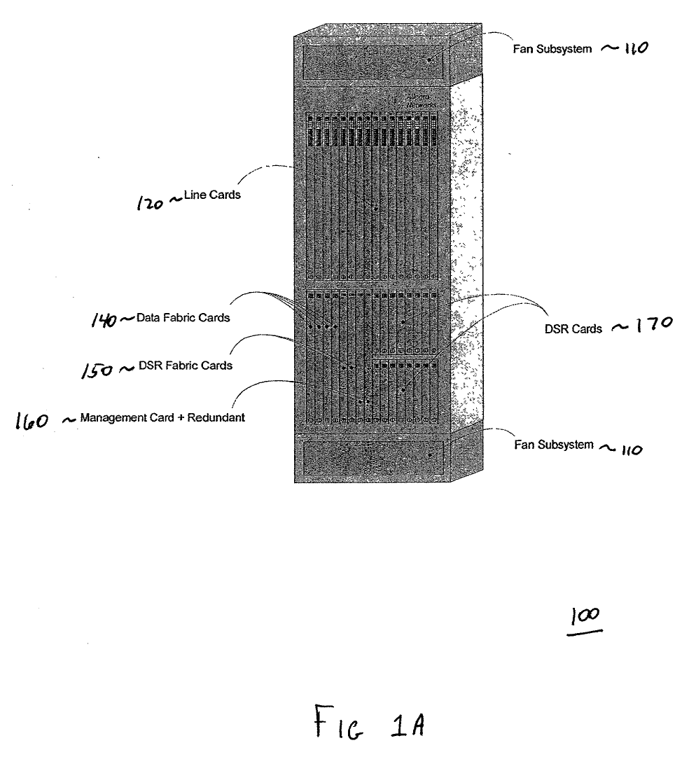

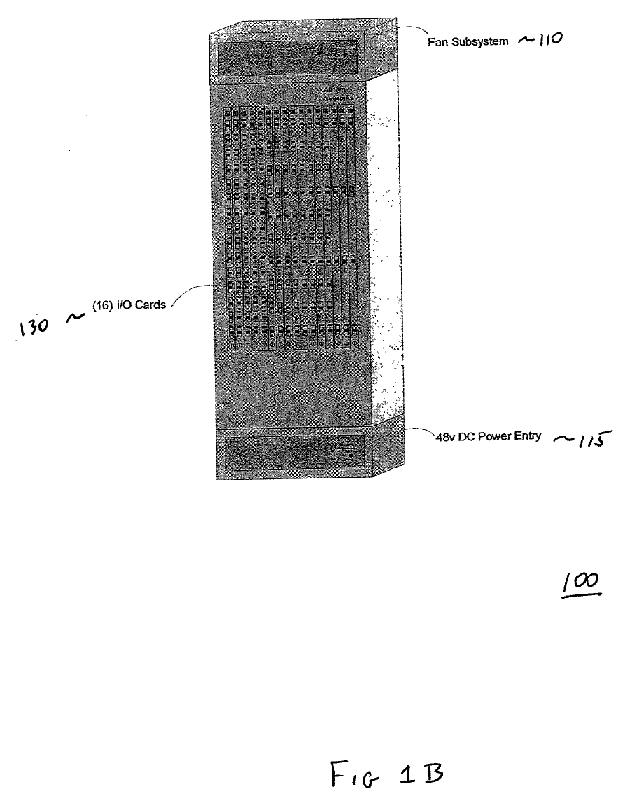

FIGS. 1A and 1B demonstrate an exemplary embodiment of a rear and front view, respectively, of a chassis design 100 for a system implementing an embodiment of the present invention.

In FIG. 1B, a plurality of I/O modules on I/O cards 130 are associated with line cards 120, and define multiple ports over which data may enter/exit the system. Data transmitted over these ports may be further separated into various channels, and the ports/channels may be grouped to define a Network Interface. Upon receipt of traffic that must be routed before being forwarded, information is communicated to Distributed Service Routers (DSRs) on DSR cards 170, where routing instantiations are performed. Thereafter the traffic may be immediately forwarded. Data fabric cards 140 and DSR fabric cards 150 provide a data transportation medium for the invention, and Master Management Card (MMC) 160 oversees the above operations, and manages and assigns resources within the system, as will be described in more detail below. Using the above-mentioned elements, the system may switch (i.e., forward) most data traffic at line rate.

Traffic over any of the plurality of ports (and/or channels) can be freely assigned to any one of the DSRs for routing, and to a corresponding one of the line cards for forwarding. In this way, a given service provider accesses what is effectively his or her own routing system, and can thereby provide Internet access to his or her customers accordingly. Traffic can be channelized and/or aggregated over the plurality of ports in virtually any manner that is desired by a user and implemented via the management card 160.

With traditional routing architectures, the entire route processing and forwarding is centralized in a single location (e.g., the route-switch processor on a traditional router). Some conventional routers use ASICs to perform distributed forwarding, but still maintain a single centralized instantiation of routing. By contrast, in the present invention, all route processing and forwarding is physically distributed on the individual line cards 120, and these independent routing instantiations are the Distributed Service Routers (DSRs) mentioned above.

In short, DSRs are individual, carrier-class routers within the chassis described above, which have the job of managing Network Interfaces based on customer requirements. Each DSR has the capability to build its own Routing Information Base (RIB), Forwarding Information Base (FIB), participate in routing protocols, specify policies, and direct switching of packets to and from ports under its control.

DSRs can be completely isolated from one another, so that, for example, various service providers can share the different DSRs, and the failure of one DSR does not cause the failure of the others. Thus, a crash on a single DSR does not affect overall system resource availability, nor does it affect any other DSR. Each DSR's routing and forwarding is completely independent of other DSRs. Each DSR will be capable of storing two versions of a required operating system and its associated modules for fault tolerance and redundancy. Back-up DSRs within the system provide functionality similar to redundant route switch processors on traditional routers.

With the configuration described above, it is evident that the present invention is very scaleable to the incremental needs of customers. For example, a carrier can purchase an additional DSR Card and a few Line Cards to provide resources for a new medium-to-large customer. For smaller service providers, the carrier can simply add the new DSR service to an existing DSR Card that has enough resources to spare, and can assign a few remaining channels on any existing Line Cards. In this case, the carrier would not even have to purchase any new equipment for the expanded business.

DSRs are physically distributed throughout the chassis via additive CPU modules, which reside in a DSR bank at the rear of the chassis, as discussed above and shown in FIG. 1A. Each DSR has the ability to perform wire-speed forwarding on all interfaces within the chassis. Each DSR's Routing Information Base (RIB) and Forwarding Information Base (FIB) are cached on the line cards, and once routing information is received and populated, the entire system forwards at line-rate.

Traditional routers use a two dimensional lookup, where the forwarding vector for a data packet is determined solely by the Source IP address and Destination IP address of the packet. All of the routing policies are implemented by a single autonomous system. However, the present invention has routing policies (from multiple autonomous systems) with completely different RIBs/policies. To carry-out the policies from different autonomous systems, the present invention essentially uses a three dimensional routing table, with a third dimension being the system (e.g., one or more DSRs) associated with the interface through which the packet entered the chassis.

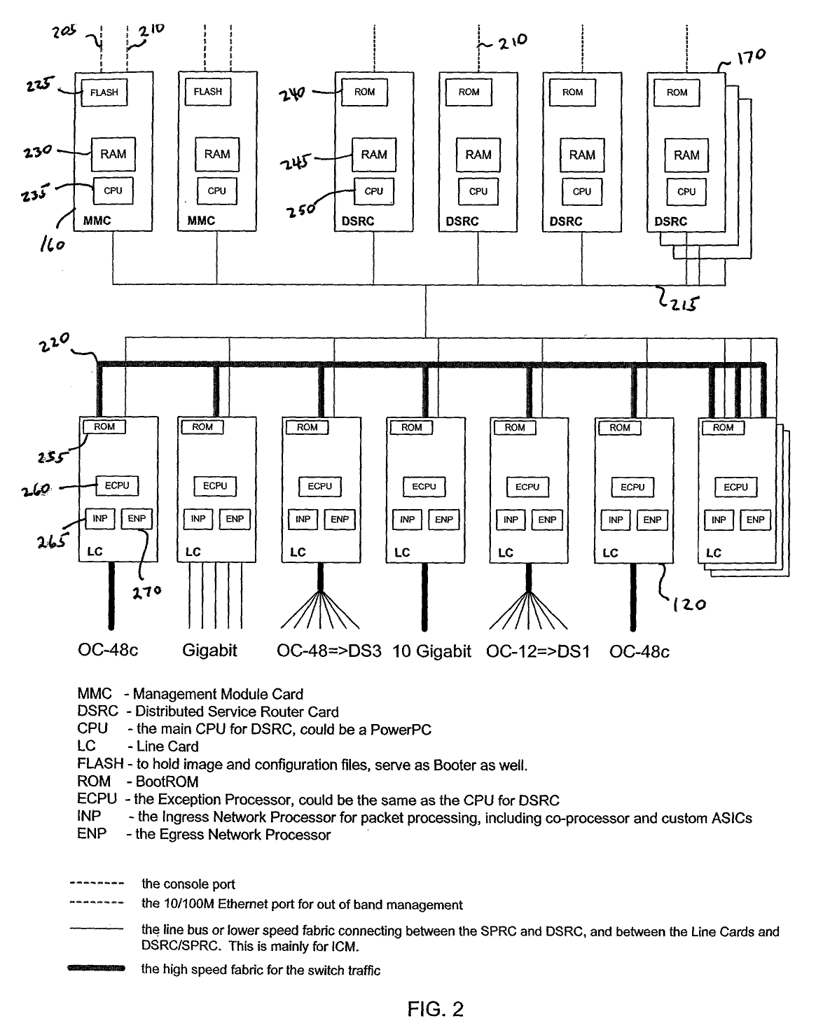

FIG. 2 demonstrates a high-level hardware component overview of the above-described components. In FIG. 2, MMC 160 (note that a redundant MMC 160 for increasing system reliability is also shown, and will be discussed in more detail below) is connected to a console port 205, which is essentially a connection that ensures a minimum level of direct control of the MMC (for example, if a user were unable to establish a telnet connection). Element 210 represents a 10/100M Ethernet port for each of the MMC and DSR Cards, which users can use for out of band management of the MMC/DSRs. The MMC is connected to the DSRCs 170 and the Line Cards 120 via a line bus or lower speed fabric 215 (housed in the DSR fabric cards 150) for connecting the LCs and DSRCs. Element 220 represents the high speed fabric (housed in the Data Fabric Cards 140) for switch traffic.

MMC 160 contains a flash memory 225, generally for use in booting, as well as RAM 230 and CPU 235. DSRCs 170 each contain ROM 240 for use in booting, RAM 245, and CPU 250. LCs 120 each contain ROM 255 for use in booting, Ingress Network Processor (INP) 265, Engress Network Processor (ENP) 270 and Exception Processor (ECPU) 260. As shown in FIG. 2, I/O ports to LCs 120 can utilize a variety of connection speeds and feeds. For example, one LC may have a single port transmitting OC-48 or 10 Gigabit traffic, while another LC may be channelized from OC-48 to DS3.

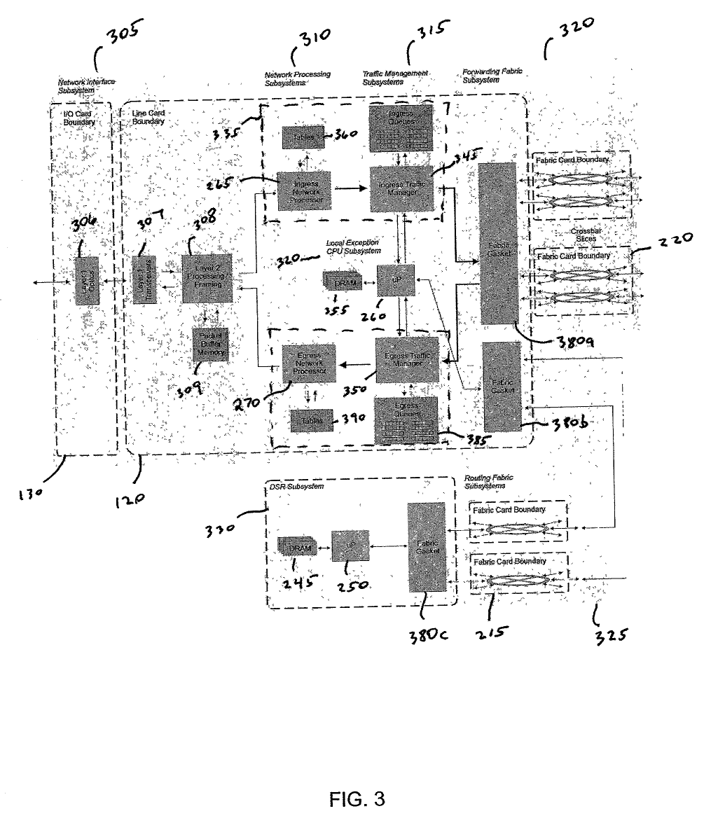

Regardless of the choice of aggregation and/or channelization of data as just described, packets of data generally flow through the system of FIGS. 1 and 2 as demonstrated in FIG. 3. As described above, packets and/or information concerning the packets flow traverses either a forwarding path (data plane) or a routing path (control plane) depending on the packet characteristics; i.e., whether the packet is of a type that has been recognized and has had routing information retrieved, or whether it is a packet that is not recognized by a routing table.

The forwarding path comprises the network interface subsystem 305 (comprising an I/O Card Boundary containing Layer 1 Optics 306, layer 1 transceivers 307 and Layer 2 processing/framing section 308 (which buffers incoming packets using packet buffer memory 309)), the networking processing subsystems 310 (comprising Ingress Network Processor 265 and associated Tables 360, as well as Egress Network Processor 270 and associated Tables 340), the traffic management subsystem 315 (comprising Ingress Traffic Manager 345 and Ingress Queues 365, as well as Egress Traffic Manager 350 and associated Egress Queues 385) and the forwarding fabric subsystem 320 (comprising fabric gasket 380a and fabric card boundaries 220).

The routing path comprises the network interface subsystem 305, the networking processing subsystems 310, the traffic management subsystem 315, the local exception CPU subsystem 320 (comprising Local Exception CPU 260 and associated memory 355), the routing fabric subsystem 325 (comprising fabric gasket 380b and fabric card boundaries 215) and the DSR subsystem on DSR Card 170 (comprising CPU 250, associated memory 245 and fabric gasket 380c).

Thus, packets for which routing information has already been determined, and that enter on a channel or port assigned to a particular user, are forwarded along the forwarding path to that user. For unrecognized packets on such a channel or port, in one embodiment of the invention, the packets are sent through the Local Exception CPU Subsystem 320 to a corresponding DSR, where routing instantiations are performed. This particular embodiment is discussed throughout this description, for the purposes of clarity and convenience. However, the present invention also contemplates separate embodiments, wherein only some subset of information from each packet (or information derived from or based on each packet) need be sent to the corresponding DSR for routing instantiation. In all embodiments, such packets will thereafter be recognized and forwarded at line speed.

It should be noted that, although FIG. 3 has been discussed with relation to a line card 120 and associated DSR Card 170, a system implementing the present invention does not require a one-to-one correspondence between a line card and a DSR card. For example, groups of ports on a given line card may be divided between a plurality of corresponding DSRs, which may or may not be on a single DSR card. Similarly, a DSR may have ports from multiple line cards associated therewith. Such communication between the ports, line cards and DSR cards is made possible by the various fabric subsystems.

The above description provides a general basis for understanding an exemplary operation (and various advantageous features) of the present invention. Hereafter, a more detailed description of FIGS. 1-3, as well as a software architecture for implementing an embodiment of the present invention, will be described.

The Ingress Network Processing Subsystem 335 is responsible for applying the following functions to the ingress traffic stream: parsing and field extraction, field checking and verification, address resolution, classification, security policing, accounting and frame translation (editing, modification, etc.)

The Egress Network Processing Subsystem 340 is responsible for the following functions: frame translation, field checking, accounting and security.

All of the classification rules and policies that are enforced within the network processing subsystem 310 come from a Network Processor Initialization software process and are given to the hardware at the time a DSR agent is spawned. The network processor interacts with the DSR Manager to gain information related to security policies, policing policies, and classification rules. These topics are discussed in more detail below.

When packets enter the system, the Network Processing Subsystem 310 performs a lookup based on the source physical port (and thereby associated DSR), Source MAC address, Destination MAC address, Protocol Number (IP, etc.) Source IP Address, Destination IP Address, MPLS label (if applicable) Source TCP%UDPai Port, Destination TCP/UDP port, and priority (using DSCP or 802.1P/q).

The classification rules can look at any portion of the IP header and perform actions based on the policies associated with the classification rules. Traffic that does not match any classification rules can be forwarded in a default manner as long as it is not matched by a security engine or does not exceed the customer's service level agreement (SLA).

The rate of incoming packets can be compared to rate limiting polices created during system provisioning. If the rate of packets exceeds a programmable threshold, the packets may be marked for discard, based on priority or a number of rules in the classification and queuing engines. Ultimately, the policing function is enacted in the ingress traffic manager 345 (described below). At the egress, packets can be rate limited by quality of service policies created at the time of provisioning. The egress network processor 270 and the egress traffic manager 350 enact rate shaping.

All traffic flowing into the system can be accounted based on the source physical port, Source IP address, destination IP address, priority, source TCP/UDP port, destination TCP/UDP port, classification rule, or any combination of the above.

The packet then enters Network Processing Subsystem 310; after a packet has been processed a determination is made as to whether it should pass through the system's data forwarding plane, should be dropped, or forwarded to the traffic management subsystem 315.

There are many determining factors on how specific packets are to be handled. If it is management traffic, it can be forwarded to the local exception processor 260 (associated with local exception memory 355) on the line card 120. If the packet is dropped it is still accounted. Finally, if the packet is to be forwarded, a customer accounting identification is created, appended to the header of the traffic, and passed on to the traffic management subsystem 315 for accounting.

The Traffic Management Subsystem 315 is broken into autonomous ingress and egress functions. Both ingress and egress functions can be supported by one programmable chipset. The Traffic Management Subsystems 315 are responsible for queuing packet data and maintaining the precedence, minimum bandwidth guarantees, and burst tolerance relationships that are set by the provisioning templates or Service Level Agreements (SLAs). It is the responsibility of the Network Processing Subsystem 310 to assign a Flow ID to received packets.

The ingress network processor 265 uses tables 360 to classify a packet based on any combination of the following fields and the originating physical port(s) associated with a DSR: physical port, DSR ID, L2 Source Address, L2 Destination Address, MPLS Label, L3 Source Address, L3 Destination Address, L4 Source Port, L4 Destination Port, priority (i.e. DSCP/IP TOS/VLAN precedence)

The Traffic Manager queues packets in Ingress Queues 365 based on the Flow ID that is generated by the ingress network processor 265. There can be two levels of queuing in the system. The first level can be for destination interface modules, which can be implemented at the ingress point of the network. The packet can then be forwarded across the switch fabric to the destination module where, in a second level of queuing, the packet is placed into specific queues 385 associated with destination egress ports. Then, Egress Network Processor 270, using classification tables 390, passes the packet to those ports.

This queuing technique provides high performance for multicast because fewer packet replications need to take place in the fabric subsystem, and the local egress traffic subsystem provides packet replication for multicast.

The crossbar fabric subsystem shown within fabric card boundaries 220 provides the transport and connectivity function within the forwarding subsystem, and is spatially distributed in the chassis between line-cards and fabric cards.

To glue the traffic management function to the fabric, fabric “Gasket” functions 380 populate each line card and DSR card. These gaskets provide the transceiver function as well as participating in the fabric control and scheduling mechanisms. The multiple crossbar “slices” on each fabric card can provide a 32×32 cross-point array that is scheduled in an autonomous fashion by each crossbar slice. The crossbar functions can be arranged in slices, providing favorable redundancy and extensibility characteristics.

In the above-described embodiment, the present invention operates with −48 Volt DC power supply 115 or an optional AC power supply (not shown). The system is designed with modular and redundant fan subsystem 110 that cools the system from the bottom of the front to the top-rear of the chassis. The chassis can also support 2 network clock cards (1+1 redundant) and an alarm card (not shown).

Note that FIG. 1 shows 16 line cards 120, along with 16 I/O cards 130. However, the number of I/O modules is extremely flexible, and so the number of I/O modules can easily scale up or down to the needs of a particular customer (e.g., a service provider) simply by adding or subtracting line cards and/or DSR cards, as discussed above.

The system can have a 3+1 redundant fabric, where the 4^{th} fabric can be used to provide redundancy and improved performance characteristics for multicast and unicast and Quality of Service (QOS) traffic. Although two fabrics can handle all unicast, multicast and QOS-enabled traffic, incremental fabrics provide improved performance characteristics including more predictable latency and jitter.

In the above description, all cards are hot swappable, meaning that cards can be added, removed and/or exchanged, without having to reboot the system. All physical interfaces are decoupled from the switch's classification engines and forwarding fabric. In addition, the switching fabrics are decoupled from both physical interfaces and the classification engines.

DSRs are slot, media, and interface independent, meaning that a DSR can have, for example, DS1, DS3, OC-3, OC-12, OC-48c, OC-192c, Fast Ethernet, Gigabit Ethernet and 10 Gigabit Ethernet. Using this model, users can add any port to their DSRs through the use of automated provisioning software. Each channelized port within a SONET bundle can be provisioned to different DSRs.

Note that a DSR is not itself a physical entity or card; rather, it is a software construct that resides on a DSR Card. The DSR that is the router for the carrier itself is referred to herein as the SPR, and resides on a CPU on a corresponding SPR Card. A given DSR card can harbor one or more DSRs, where this number is limited by the processing and memory requirements of the individual DSRs. That is, an entire DSR might be reserved to run a relatively complex routing protocol such as Border Gateway Protocol, whereas many DSRs can be run on a single DSR Card if the DSRs are running a simple routing protocol such as Routing Information Protocol (RIP).

The software and operating system is written such that different protocols are modular and can be upgraded without upgrading the entire operating system, which promotes maximum system uptime. Individual DSRs within the system are capable of running different routing code and software to promote maximum uptime. During maintenance windows, any elements within the system software can be upgraded without a hard reboot of the system.

Specific measures can be implemented in the hardware to prevent distributed denial of service attacks (DDOS). Some of these measures including reverse path checking in hardware, rate-limiting measures, and the default behavior enabled to block well known denial of service attacks.

Given the physical and logical independence of DSRs, they can be wholesaled to customers; effectively allowing hundreds of carrier-class routers to be co-located inside of a single chassis. Additional DSRs can be added by adding incremental compartmentalized CPU/memory (DSR) modules. Each DSR is capable of running standard unicast/multicast routing protocols. The system can be “sliced” in any way a carrier wishes. It can act as a single large dense aggregation device with a single router instantiation with specialized distributed hardware forwarding engines; as many smaller aggregation routers acting independently with specialized distributed forwarding engines; or as a hybrid that has a large aggregation router as well as many smaller aggregation routers.

Additionally, the present invention can provide unprecedented levels of SONET Density and aggregation; by maintaining the intelligence in the hardware and software for very advanced features and services, and by using SONET interfaces that span from VTI1.5 to OC-192, the present invention can allow carriers to bypass cross connects and plug directly into Add-Drop Multiplexers.

In one embodiment, the present invention will have an 80 Gbps capacity (40 Gbps switching fabric). Three line cards can be used in this embodiment, which are: 1 port OC-48c, 1 port OC-48 channelized to DS-3, and 4 port OC-12 channelized to DS-1

In another embodiment, the line cards may comprise a 4-port gigabit Ethernet card with GBIC interfaces.

The OC-48 SONET interface supports a clear channel 2.5 Gbps or any combination of the following channelization options: DS-3, E-3, OC-3c, or OC-12c.

The four-port OC-12 SONET interface supports channelization to DS-1/E1. Any valid combination of channelization can be done within the OC-12 interface, but it should comply with DS-1 frames encapsulated in OC-1 or DS-3 (parallel scenario for T1/E1).

Additional embodiments can be based on 10 Gbps per slot. In these embodiments, the following interfaces can be prioritized: 4 Port OC-48 channelized down to DS-3 (or 4 port OC-48c); 4 port OC-12 channelized down to DS-1; 10 Port Gigabit Ethernet; 1 Port OC-192c (10 Gigabit Ethernet); 12 Port OC-12c ATM; or DWDM.

The system for provisioning services in the present invention should be designed to be as automated as possible to reduce the administration time, complexity, and intervention for carriers and service providers. Service provider customers can request resources, and if those resources are granted, the available resource account is debited, and the system begins billing the service provider for the new resources that it is using. The primary way that many service provider customers will use for provisioning will be through direct Command Line Interface (CLI) input or configuration scripts. A graphical user interface can be made available that adds access to statistics and configuration through a web interface. Whether configuration takes place from the CLI, configuration script, or GUI, all provisioning and configuration drives the CLI for the invention itself.

In one embodiment of the invention, the Network Management System (NMS) for the present invention will focus on an EMS (Element Management System) to manage the system. The complexity of the invention will require that this traditional NMS model will need to be collapsed into one system to form its EMS model. From this standpoint a single chassis as described above can be viewed as its own network where there are many individual devices (objects) to be managed. Two different views of management can be offered, one from the perspective of the carrier and the other from the viewpoint of a DSR owner. A further view will also be supported that will offer the third tier (or end customers) to view their provisioned services and performance data for auditing. These views can be enabled, disabled, managed or customized by the carrier.

The above-discussed provisioning system follows a three-tiered model for selling services. This model includes concepts that may be referred to as follows: the Master Management Console (MMC), controlled by the carrier; the Service Provider Console (SPC), controlled by the service provider or value added reseller; and the Customer Access Console (CAC), which a customer can use to audit SLAs.

The MMC is divided into two sections acting as a client/server architecture, respectively (as well as a management provider layer). The client portion provides the user interface, the graphics, and console display functions. The server portion provides the intelligence to parse the requests from the client, dispatch commands to the various subsystems to provision resources, gather events, log and challenge access permissions and perform the management functions for the system.

In one embodiment, there will be only one active MMC. That is, although an MMC will be located on both of the Management Modules, only one of the Management Modules will have active control within the chassis. The secondary Management Module will take over the primary during an emergency that prevents the primary from performing its responsibilities. If the secondary module does assume control, it does not require the system to reboot.

The MMC will provide a central point of network administration for the carrier. Some of the features to be managed include Fault Detection, Resource Provisioning —(Configuration Management), Monitoring (Performance Management), Accounting and Security.

The Service Provider Console (SPC) allows service providers and resellers to provision services using the present invention. As with the MMC, the SPC is divided into two sections acting as a client/server architecture, respectively (as well as a service provider layer). The client portion provides the user interface, the graphics, and console display functions to the service provider. The server portion provides the intelligence to parse the requests from the client, dispatch commands to the various subsystems to provision resources, gather events, log and challenge access permissions and perform the management functions for the system.

With a stand-alone router, there is conventionally one console port per physical router. The console port, referred to above, is a serial port that requires a dedicated console cable. The console port allows a user to be connected to the router when reboot events occur or when a configuration is completely lost. Some of these functions of the console cable include connectivity during reboots for hardware/software upgrades, password break-in (due to misplaced passwords), and diagnostics.

However, it is not physically feasible to have hundreds if not thousands of serial cables attached to a system implementing the present invention for individual console access to each DSR. Therefore, to provide the functionality of the console port a virtual terminal server can be implemented within the system. Such a virtual console can allow a service provider customer to troubleshoot and configure their DSR router with no carrier intervention. This is consistent with the goal of the provisioning portion of the Master Management Console (MMC), which is to create an automated system, where the lessees of the DSRs have the ability to login, configure, and troubleshoot their DSR without tying up customer support resources at the carrier.

When the carrier leases a DSR, the customer gives the carrier a username/password combination (in addition to a list of other requirements for billing/accounting and emergency notification). The carrier will enter the DSR usemame/password into, for example, an existing AAA server (one that uses, e.g., Radius or Tacacs+authentication) for virtual console access to a customer's DSR. Once the service provider logs in to the virtual console, an internal telnet/SSH connection from the management module to their DSR can be created. This connection is different from a traditional telnet session to a DSR, because the user remains connected even in the event of a DSR reboot. In the event that a DSR was completely unreachable by a traditional telnet/SSH session, the lessee can be provided with a dial-up phone number from the carrier which will allow them to connect to a remote access server over a traditional POTS line and telnet or SSH to the IP address of the virtual terminal server. Thus, the service provider is guaranteed to be able to reach their DSR, independent of phoning for support at the carrier.

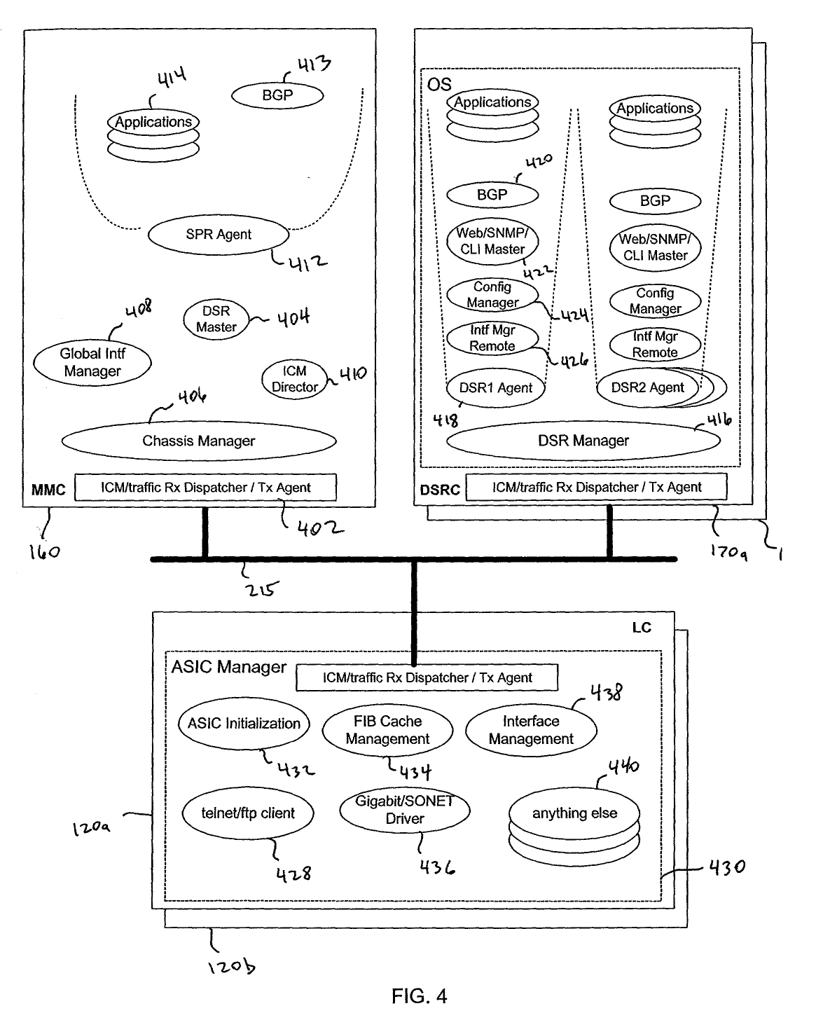

FIG. 4 demonstrates a software system implementing the above-described embodiment of the present invention, which is divided into four major elements: the Inter-Card Messaging Service Subsystem, the Management Processing Subsystem, the DSR Subsystem, and the Line Card Subsystem.

ICM Subsystem

The purpose of the ICM is to provide each chassis with its own internal network for Inter-Card Messaging. The ICM, under the direction of ICM director 410, utilizes control fabric 215 that is separate from the data forwarding fabric 220. The ICM subsystem is used to provide event and messaging communication between the Management Processing Subsystem on MMC 160, the DSR Subsystem on DSR Cards 170, and the Line Card Subsystem on Line Cards 120, as demonstrated in FIG. 4. This is done to reduce the complexity and cost of interconnecting all cards within the chassis. The ICM control fabric performance requirements are much lower than the high-speed data fabric since its main concern is to control information between the different subsystems. There are redundant ICM fabrics installed for load sharing as well as backup. The ICM Dispatcher 402 is responsible for receiving all ICM events, providing interpretation of the event received and dispatching the event or event to the intended destination process.

Management Processing Subsystem

As described above, there are two management cards for redundancy, and these should mirror each other during all phases of operation. The Management Processing Subsystem performs minimum diagnostics on the management card and the line cards within the system. It also initializes the Inter-Card Messaging services (ICM) to enable communication between cards within the system. Once the system has been checked, the Management Processing Subsystem will spawn the processes to bring up each of DSR cards and their respective configurations.

The Management Processing Subsystem also acts as the agent from which DSRs are provisioned, using DSR Master 404. It monitors resources within the system and proactively sends alerts of any resource shortages. The Management Processing Subsystem is the central point where billing and accounting information is gathered and streamed to a billing and accounting server. Additionally the virtual terminal server, and many other services for the chassis can be spawned from this subsystem.

The operating system in Management Processing Subsystem and the DSR Card Subsystem should be the same. Because of the potential large number of DSRs that may be operating, it would be beneficial for the operating system to be a very efficient multi-tasking operating system that offers complete memory protection between tasks. Some advantageous features of the operating system would be: extremely efficient context switching between tasks, memory protection between tasks, normal interrupt handling and non-maskable interrupt handling, watchdog timer and real time tick support, priority setting among tasks, rich library support for Inter Process Communication, task locking and semaphore support, run time memory management, storage device driver support and small kernel size for the embedded system.

The chassis manager 406 is a task that resides in the Management Processing Subsystem. Its job is to manage the overall chassis health and activity. It is the first task that is spawned after the operating system is online. The chassis manager 406 plays a major role in assisting in hardware redundancy. The chassis manager 406 maintains a database of all the physical hardware components, their revision numbers, serial numbers, version Ids, and status. The chassis manager 406 can be queried by the management system to quickly see the current inventory of software and hardware, which assists in inventory and revision control. Additionally, the chassis manager 406 monitors and detects any addition of physical components for online insertion of any/all hardware. The chassis manager 406 reports on temperature, CPU utilization, memory usage, fan speed and individual card statistics. The chassis manager 406 maintains the responsibility for all configuration files for each DSR. This is the element that is responsible to tell each DSR which file is their active configuration and points the DSRs to their active configuration files.

The Global Interface Manager 408 resides in Management Processing Subsystem. Each of the DSRs only see the ports that have been assigned to their routing instantiation. The Global Interface Manager 408 maps the local ports within the DSR to the master global map that defines the location of a particular port. The Global Interface Manager 408 assigns a unique logical port ID for every port within the system (this can be from a clear channel port to a PVC). Additionally the manager receives information from the line card drivers about global port status.

The Management Processing Subsystem may comprise various other software objects/agents, as would be apparent. For example, SPR Agent 412 (utilizing a routing protocol such as BGP 413 and various other applications 414) may reside on the MMC.

DSR Subsystem

As described above, the DSR subsystem allows multiple isolated routers to be co-located within a single chassis. Each DSR is run by a microprocessor and associated memory. Having isolated CPU modules for DSRs provides at least the following benefits: the ability to physically isolate the routers, the ability to add incremental upgrade processing power as needed and the ability to decouple distributed routers from the management module (which provides added resiliency).

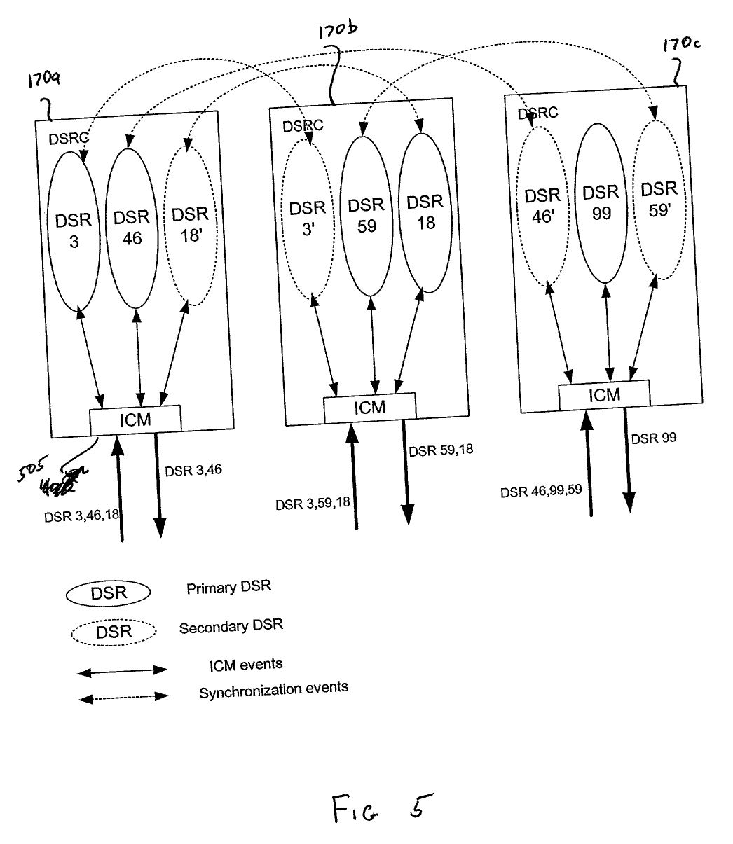

The DSR subsystem is shown with respect to FIGS. 4 and 5. It is important to note again that it is contemplated within the present invention to provide multiple DSRs (such as DSRs 3 and 46) on each DSR card 170. To implement this concept, in one embodiment, DSRs communicate within I/O modules and the management module through the system's software DSR Manager 416. The Software DSR manager 416 controls various functionalities shown in FIG. 9 through the use of DSR agents 418, including local DSR protocol configuration 420, CLI/Web/SNMP management 422, configuration 424, classifications, and various other software objects/agents, as would be apparent.

The DSR subsystem communicates with the exception processor subsystem 260 on each I/O module via its own modular switch (data) fabric. The DSR subsystem interacts with the software FIB cache manager, software Network Processor Manager, and statistic gathering functions on the exception processor. In addition, the DSR can populate the access list engine, policing engine, and classifiers located within the network processor.

The purpose of the DSR processor subsystem is to provide exception handling for all the components that are physically located on the line-card, initialize the devices on the card after a reset condition, allow telnet and other such sessions terminating on the line card 120, and permit RIB management and routing protocols.

Each of the DSRs are tied to the physical distributed routing cards 170. Within each DSR card 170, there is a DSR Manager 416. The DSR Manager 416 is the point-of-contact on the DSR Card for the Chassis Manager 406, and as such it interacts with the Chassis Manager 406 to notify it of its existence and the health of the DSR's CPUs. This task only resides in the DSR Card 170 and should be the first task that is spawned after the operating system is successfully loaded.

Each DSR has its own DSR agent 418. The DSR agent 418 manages all application tasks for a DSR. There is no sharing of tasks or data structures among different DSR agents. This allows each DSR to function completely independent of one another. All application tasks are spawned from their DSR agent. It is the job of the DSR agent to detect any child processes that have problems. If a process were to crash, a detailed notification message would be sent to the master management module, and the DSR agent can re-spawn the application tasks immediately. Additionally, a DSR agent can receive an administrative shutdown from the DSR master to prevent the process from constantly re-spawning if the application does not terminate in a given period of time.

The Interface Manager Remote 426 resides in each DSR Card and can be spawned per instance by each DSR Agent. It is the managerial task that is responsible for interface management within each DSR. For example, it would tell the line card that channels 1-4 on line card 1 belongs to DSR 1. The Interface Manager Remote 426 builds an interface table that contains all the port/path information of the corresponding DSR. It binds the logical ports within a DSR to the physical paths. Additionally, it is responsible for bringing interfaces up/down and informing the upper layer software of the interface status. The remote manager communicates with the Global Interface Manager 408 for port assignment and updates among some of its responsibilities.

The Configuration Manager 424 is responsible for the management and maintenance of all configuration files for each DSR. It maintains the separation of configuration files between DSRS and points to the current active configuration file. The Configuration Manager 424 retrieves the content of the configuration file into a cache so that a DSR can quickly start routing once a DSR is online.

Each DSR has an accounting manager (not shown) to collect all relevant statistics. Its primary functions are to build and maintain a database of statistics, communicate with the line card to collect information from the counters. Additionally the accounting manager has the ability to convert all of the statistics into a format that will allow the use of third party accounting applications.

In order to achieve complete carrier class redundancy, the present invention can employ the concept of hot-standby DSRs, as shown in FIG. 5. This would be similar to having two route switch processors for a DSR. FIG. 5 shows DSR Cards 170a-c, each having three DSRs labeled as 3, 46, 18′, 3′, 59, 18; and 46′, 99, 59′, respectively. DSRs shown in solid lines are considered to be in primary mode, while those in dashed lines are in secondary mode.

Thus, a hot-standby DSR would be active (primary) on one physical DSR card and waiting in standby (secondary) mode on a separate physical DSR card. There is an intelligent ICM mechanism 505 that defines which DSR is in primary or secondary mode. Through using a multicast mechanism, the DSR manager 416 keeps the backup notified of the primary DSR's status. There is a configurable preemption mechanism between the primary and backup DSRs, so if the DSR was put into backup for maintenance, the primary could re-gain control once back online.

Line Card Subsystem

The Line Card's primary function is to forward the traffic at line rate. All traffic is forwarded in hardware except for the traffic that needs to flow to the Exception Processor Subsystem 320. The local exception processing CPU 260 is responsible for handling exceptions for components located locally on each line card 120; an exception processor on one line card is not intended to assist another line card. The exception processor can be responsible for statistics and accounting gathering and forwarding and services such as Telnet or SSH that terminate on the line card (using telnet/ftp client 428, for example).

In the Line Card Subsystem shown in FIG. 4, there is a driver called the ASIC Manager 430. The ASIC Manager's responsibility is to initialize (using ASIC Initialization 432) and monitor the ASICS and the Data Fabric Card and its software components. It handles all the external event commands from any process within the DSR card. Additionally it reports failures to the proper process on the DSR cards. ASIC Manager may include various other tasks, such as FIB cache management 434, Gigabit/SONET Driver 436, Interface Management 438, or anything else 440, as would be apparent.

A multicast subscription table can be included in every line card for any packets that require multicasting. All the multicast protocols would interface with the Multicast Subscription Manager to set up the table. There can be two such tables in the line card, one for the slot multicast and one for the local port multicast.

In conclusion, the above description has provided various explanatory embodiments with regards to a routing arrangement that is capable of providing broadband interfaces on a port-by-port basis. As already explained, such an arrangement can be achieved by channelizing data traffic over a plurality of I/O ports, and then defining certain channels/ports as a Network Interface for a particular service provider. Traffic over these Network Interfaces can then be routed and/or forwarded using a plurality of line cards and Distributed Service Routers, all preferably contained within a single router chassis. The routing and forwarding operations can thus occur without need for any centralized routing/forwarding processor, and can instead occur completely independently for each service provider. In this way, service providers have access to broadband Internet access that can be used or leased to their respective customers, and this access is reliable, and can easily be scaled up or down to meet the needs of the service providers at any given time.

While this invention has been described in various explanatory embodiments, other embodiments and variations can be effected by a person of ordinary skill in the art without departing from the scope of the invention.

What is claimed is:

1. A routing device comprising:
a plurality of ports that input and output network traffic that is separated into at least one channel per port;
a plurality of network interfaces, each comprising at least one channel; and
a plurality of routers,
wherein any one of the plurality of network interfaces is assigned to any one of the plurality of individual routers.

2. The routing device of claim 1, wherein each of the plurality of routers has associated therewith an independent routing instantiation relating to its corresponding network interface.

3. The routing device of claim 1, wherein a routing policy implemented by each of the plurality of routers identifies data packets traversing each network interface with their corresponding router.

4. The routing device of claim 1, wherein each network interface and its corresponding router is assigned to a particular user.

5. The routing device of claim 4, wherein a maximum amount of network traffic is assigned to each network interface and its corresponding router, in accordance with bandwidth requirements of the corresponding user.

6. The routing device of claim 1, wherein each router comprises a software construct that resides on a router card within the routing device.

7. The routing device of claim 6, wherein each router card comprises a microprocessor and an associated memory.

8. The routing device of claim 7, further comprising a plurality of router cards, each router card comprising at least one router.

9. The routing device of claim 8, wherein each of the plurality of router cards is hot-swappable.

10. The routing device of claim 8, wherein a primary router on a first router card is associated with a secondary router on a second router card, such that the secondary router assumes the function of the first router upon a failure of the first router or a designation by an operator of the routing device.

11. The routing device of claim 8, further comprising:
a plurality of line cards, each including storage for on which routing and forwarding information for an associated router.

12. The routing device of claim 11, wherein the plurality of line cards include a plurality of independent forwarding tables that are in a one-to-one correspondence with the plurality of routers, and include information to identify network traffic for forwarding through the routing device.

13. The routing device of claim 11, further comprising:
a management card for managing the routing device that is connected to the router cards and the line cards via a first medium.

14. The routing device of claim 13, wherein the first medium comprises a first fabric housed on a first set of fabric cards.

15. The routing device of claim 14, further comprising:
a second medium, comprising a second fabric, that connects the line cards, wherein the second fabric comprises a high-speed fabric operable at approximately line rate.

16. The routing device of claim l, wherein the plurality of routing devices are logically and physically independent of one another.

17. The routing device of claim 1, wherein the plurality of individual routers are contained within a single chassis.

18. An apparatus for routing data in accordance with routing schemes for a plurality of customers, the apparatus comprising:
a plurality of input/output modules, each module including at least one port including at least one data channel,
a plurality of independent routers each having associated therewith a plurality of data channels; and
a control fabric coupled to said input/output modules;
wherein one of said plurality of input/output modules includes a plurality of channels, a first subset of which are associated with a first one of said plurality of independent routers and a second subset of which are associated with a second one of said plurality of independent routers.

19. The apparatus of claim 18, wherein each of the independent routers is a software construct residing on at least one router card.

20. The apparatus of claim 19, further comprising:
a plurality of line cards that are associated with the independent routers and that include storage for routing and forwarding information for their respective routers; and
a data fabric connecting the line cards.

21. The apparatus of claim 20, further comprising:
a management card for managing the apparatus that is connected to the router cards and the line cards via the control fabric.

22. The apparatus of claim 21, wherein each independent router is configured according to requirements of a customer associated therewith.

23. An apparatus for routing data in accordance with routing schemes for a plurality of customers, the apparatus comprising:
a plurality of input/output modules, each module including at least one port, including at least one data channel;
a plurality of routing modules, wherein one of said plurality of routing modules includes a plurality of routing tables wherein said plurality of routing tables define routing requirements for a plurality of routers; and
a router fabric coupled between said plurality of input/output modules and said plurality of routing modules.

24. The apparatus of claim 23, wherein each of the routing modules includes software objects that are individually assigned to one of the plurality of customers, wherein the software object is provisioned to route data in accordance with respective data requirements of the plurality of customers.

25. The apparatus of claim 24, further comprising:
a plurality of switching modules, each including storage for routing and forwarding information that corresponds to one of the routing modules.

26. The apparatus of claim 25, wherein the switching modules comprise software objects that are attached to the routing modules via the router fabric.

27. The apparatus of claim 25, further comprising:
a switch fabric that connects the switch modules and forwards the data with previously-determined routing characteristics at approximately line rate.

28. The apparatus of claim 25, further comprising:
a management module through which an operator of the apparatus or one of the customers provisions and assigns the resources of the apparatus, including the capacity and number of routing and switching modules, to a customer.

29. A method for managing data flow in a data routing environment, the method comprising:
receiving first data packets on a first channel of an input/output module;
querying a first router for routing information for the received first data packets;
routing said first data packets through a control fabric, based on a response to the querying of the first router;
receiving second data packets on a second channel of the input/output module;
querying a second router for routing information for the received second data packets; and
routing said second data packets through the control fabric, based on a response to the querying of the second router.

30. The method of claim 29, wherein said receiving first data packets on a first channel of an input/output module further comprises:
determining whether routing characteristics for said first data packets have been previously assigned, and, if so, forwarding the first data packets accordingly,
and further wherein said receiving second data packets on a second channel of the input/output module further comprises:
determining whether routing characteristics for said second data packets have been previously assigned, and, if so, forwarding the second data packets accordingly.

31. The method of claim 30, wherein said forwarding the first and second data packets occurs over a data plane, and further wherein said routing said first and second data packets occurs over a control plane.

32. The method of claim 29, further comprising:
configuring the resources of the first and second router in accordance with data requirements of a first and second customer, respectively.

33. A method of routing and forwarding network traffic, comprising:
defining a network interface by assigning at least one channel on an input/output port to the network interface;
assigning the network interface to any one of a plurality of routers;
assigning the interface and the router to a user;
inputting the network traffic through the interface; and
routing and forwarding the network traffic using the assigned router.

34. The method of claim 33, wherein said routing and forwarding the network traffic using the assigned router further comprises:
caching routing and forwarding information of the router on a line card that forwards the network traffic accordingly, via a data fabric.

35. The method of claim 33, wherein said assigning the interface and the router to a customer further comprises:
provisioning a bandwidth of the network interface and the resources of the router according to a customer's requirements.

36. The method of claim 35, wherein said routing and forwarding the network traffic using the assigned router further comprises:
routing the network traffic via a control fabric that connects the line cards and the routers.

37. The method of claim 36, wherein said assigning the interface and the router to a customer further comprises:
accessing a management control card that is connected to the routers and to the line cards via the control fabric.
